(19) United States
(12) Patent Application Publication
(10) Pub. No.: US 2006/0053177 A1
(43) Pub. Date: Mar. 9, 2006

(54) System and method for backup and restoration

(76) Inventors: Riku Suomela, Tampere (FI); Ilkka Salminen, Tampere (FI); Harri Lakkala, Tampere (FI); Heikki Huomo, Oulu (FI)

Correspondence Address: MORGAN & FINNEGAN, L.L.P., 3 WORLD FINANCIAL CENTER, NEW YORK, NY, 10281-2101, US

(21) Appl. No.: 10/935,757

(22) Filed: Sep. 7, 2004

(51) Int. Cl. G06F 17/30

(52) U.S. Cl. 707/204

(57) ABSTRACT

Systems and methods whereby, for example, a node and/or other computer may act to backup data, via a proximity connection, to another node and/or other computer. Further, systems and methods whereby, for example, a node and/or other computer may act to receive from another node and/or other computer, via a proximity connection, previously backed up data.

### FIELD OF THE INVENTION

This invention relates to systems and methods for backup and restoration.

### BACKGROUND INFORMATION

In recent years, users have increasingly come to rely upon computers (e.g., wireless nodes) for storage of various data. For example, users have come to store contacts data, schedule data, documents, software, and media.

Accordingly, there may be interest in technologies that facilitate such use of computers.

### SUMMARY OF THE INVENTION

According to various embodiments of the present invention there are provided systems and methods applicable, for example, in providing data backup and restoration for nodes and/or other computers.

In various embodiments, a node and/or other computer might act to backup data, via a proximity connection, to another node and/or other computer.

Moreover, in various embodiments, a node and/or other computer might act to receive from another node and/or other computer, via a proximity connection, previously backed up data.

### BRIEF DESCRIPTION OF THE DRAWINGS

FIG. 1 shows exemplary steps involved in setup according to various embodiments of the present invention.

FIG. 2 shows exemplary steps involved in backup according to various embodiments of the present invention.

FIG. 3 shows further exemplary steps involved in backup according to various embodiments of the present invention.

FIG. 4 shows exemplary steps involved in restoration according to various embodiments of the present invention.

FIG. 5 shows an exemplary computer.

FIG. 6 shows exemplary software modules employable in various embodiments of the present invention.

FIG. 7 shows a further exemplary computer.

### DETAILED DESCRIPTION OF THE INVENTION

General Operation

According to various embodiments of the present invention there are provided systems and methods applicable, for example, in providing data backup and restoration for nodes and/or other computers.

In various embodiments, a node and/or other computer might act to dispatch to another node and/or other computer, via a proximity connection, some or all of data specified for backup.

Moreover, in various embodiments, in the case where data of a node and/or other computer backed up to one or more nodes and/or other computers is to be restored (e.g., in the case where the node and/or other computer is lost or where storage of the node and/or other computer is corrupted), the data may be retrieved (e.g., via proximity connection) from the one or more node and/or computers to which it was backed up.

Various aspects of the present invention will now be discussed in greater detail.

Setup

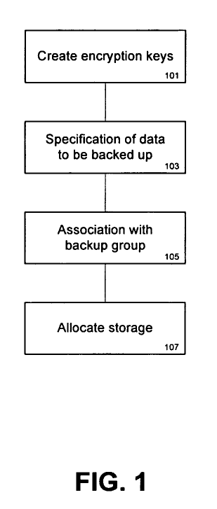

With respect to FIG. 1 it is noted that, according to various embodiments of the present invention, in the case where, for instance, backup functionality is to be provided for a node and/or other computer, one or more setup operations may be performed.

For example, one or more encryption keys employable, for instance, in encrypting data sent for purposes of backup from the node and/or other computer to another node and/or other computer might be created (step 101). Creation of the one or more keys might, for example, be performed by the node and/or other computer for which backup functionality is to be provided, and/or by one or more additional nodes and/or other computers. Creation of the one or more keys might, perhaps, involve the use of one or more seeds. Such a seed might, possibly, be one chosen by and/or well known by a user of the node and/or other computer for which backup functionality is to be provided. Accordingly, for example, a social security number or employee identifier might be employed.

As another setup operations example, specification might be provided, with respect to the node and/or other computer for which backup functionality is to be provided, as to what data should be backed up (step 103). Such functionality might be implemented in a number of ways. For instance, the user of the node and/or other computer for which backup functionality is to be provided might be provided with a graphical user interface (GUI) and/or other interface whereby she can select what data of her node and/or other computer is to be backed up.

The user might, for example, be able to specify for backup types of data (e.g., contacts, schedule, documents, software, and/or media, particular stores, particular files, and/or particular directories. As another example, the user might be able to specify (e.g., via a GUI and/or other interface) corresponding priorities for that which is specified for backup. To illustrate by way of example, a user that has specified that contacts and schedule data should be backed up might be able to specify a corresponding priority for each. As is discussed in greater detail below, in various embodiments backup operations can take into account specified priorities.

As another setup operations example, the node and/or other computer for which backup functionality is to be provided may be associated with a backup group (step 105). Such functionality might be implemented in a number of ways. For instance, the user of the node and/or other computer for which backup functionality is to be provided might be provided with a GUI and/or other interface whereby she can select one or more backup groups. The user might, for example, be able to select from among one or more existing backup groups. As another example, the user might be able to create a new backup group, and select that newly-created group.

Functionality might, for instance, be such that the node and/or other computer for which backup functionality is to be provided consults held data and/or communicates with one or more other nodes and/or other computers in order to learn of existing groups. In the case where the user selects such an existing group, one or more nodes and/or other computers belonging to the selected group might, perhaps, be informed of the selection.

In the case where a new backup group is to be created, the user might, for instance, act to specify other nodes and/or other computers for the group. Alternately or additionally, communications might be established between the node and/or other computer for which backup functionality is to be provided and one or more of nodes and/or other computers to be members of the group. Such communications, as well as various other communications discussed herein, might be implemented in a number of ways.

For example, proximity connection (e.g., IEEE 802.11, Bluetooth, Ultra Wide Band (UWB), and/or Infrared Data Access (IrDA)) might be employed. As another example, non-proximity connection (e.g., General Packet Radio Service (GPRS) and/or Universal Mobile Telecommunications Service (UMTS)) might be employed. Such communications, as well as various other communications discussed herein might, for instance, involve use of Short Message Service (SMS), Multimedia Messaging Service (MMS), Hypertext Transfer Protocol (HTTP), Simple Object Access Protocol (SOAP), Remote Method Invocation (RMI), Java Messaging Service (JMS), object push, and/or the like.

Users of nodes and/or other computers might, perhaps, be queried for approval for their nodes and/or other computers to join the group being created. Accordingly, such users might be queried via a GUI and/or other interface. Pairing (e.g., Bluetooth pairing) might, perhaps, be performed among nodes and/or other computers to be members of the group being created.

It is noted that, in various embodiments, nodes and/or other computers members of a particular backup group might possess and/or be able to recognize a backup group identifier associated with the group, and/or might know of one or more of other nodes and/or other computers belonging to the group (e.g., identifiers of those nodes and/or other computers might be known). Such identifiers might, for instance, include media access control (MAC) addresses, Bluetooth addresses, and/or phone numbers. More generally, in various embodiments, identifiers might be employed in recognizing nodes and/or other computers for the performance of various operations discussed herein. As is discussed in greater detail below, in various embodiments backup operations can take into account backup groups.

As still another setup operations example, storage accessible by the node and/or other computer for which backup functionality is to be provided might be allocated (step 107) for storing backup data of other nodes and/or other computers (e.g., nodes and/or other computers of one or more backup groups of which the node and/or other computer for which backup functionality is to be provided is a member).

Accordingly, for example, the user of the node and/or other computer for which backup functionality is to be provided might be able to provide one or more specifications for such allocation. For instance, the user might be able to specify one or more storage areas and/or amounts. Such provision might, for example, be via a GUI and/or other interface provided to the user.

It is noted that the amount of storage that a particular node and/or other computer makes available to hold backup data of another node and/or other computer may or may not be equal to the amount of storage that the other node and/or other computer has made available to hold backup data of the particular node and/or other computer.

It is further noted that, in various embodiments, setup operations might be performed with respect to a node and/or other computer that acts to receive backup data from other nodes and/or other computers, but does not have any of its data backed up to other nodes and/or other computers. Such setup operations might, for instance, include one or more of the setup operations discussed above and/or analogous operations (e.g., operations regarding backup groups and/or operations regarding storage allocation).

It is additionally noted that, in various embodiments, setup functionality may be provided by way of one or more software modules.

Backup

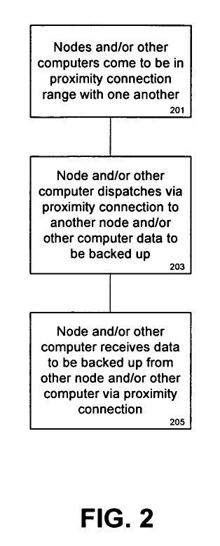

With respect to FIG. 2 it is noted that, according to various embodiments of the present invention, one or more operations may be performed in backing up data of nodes and/or other computers.

For example, a node and/or other computer may act to dispatch via proximity connection to another node and/or other computer data to be backed up (step 203). Moreover, the node and/or other computer might, perhaps, receive from the other node and/or other computer via proximity connection data to be backed up (step 205). Such proximity connections might, for example, of the sort disused above.

Such functionality might, perhaps, be triggered by the nodes and/or other computers coming to be in proximity connection range with one another (step 201). Accordingly, for example, such functionality might be triggered every time the nodes and/or other computers come into proximity connection range with one another. It is noted that, as alluded to above, in various embodiments a node and/or other computer might act to receive backup data from other nodes and/or other computers, but might not backup any of its data to other nodes and/or other computers.

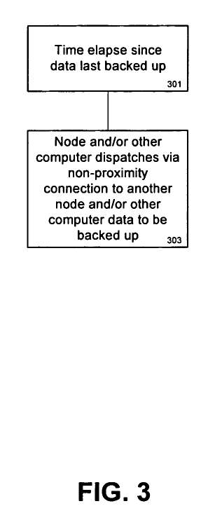

With respect to FIG. 3 it is noted that, as another example, a node and/or other computer may act to dispatch via non-proximity connection (e.g., of the sort discussed above) to another node and/or other computer data to be backed up (step 303). Such might occur, for example, in the case where a certain amount of time has elapsed since the data was last backed up (e.g., via proximity connection), (step 301).

As another example, such might be user-initiated, perhaps occurring in response to user request (e.g., via GUI and/or other interface). As yet another example, such might occur in accordance with a combination of time elapse and user-initiation. For instance, after some predefined time has elapsed since last backup, the user might be queried (e.g., via a GUI and/or other interface) as to whether or not a non-proximity connection should be established for backing up data.

An elapse amount of time might be specified, for instance, by a user of the node and/or other computer, by a system administrator, and/or by a manufacturer. Such functionality might, for example, act to ensure that backup for a node and/or other computer occurs in the case where that node and/or other computer fails to come into proximity connection range with a node and/or other computer to which it would send data to be backed up. In various embodiments, dispatched data to be backed up may be encrypted (e.g., via one or more keys of the sort discussed above).

It is noted that, in the case where there is specification with respect to a node and/or other computer as to what data should be backed up, data sent to another node and/or other computer may, perhaps, correspond to the specified data. It is further noted that, in the case where backup groups are employed, a node and/or other computer belonging to a particular group might, perhaps, act to send data to be backed up to a node and/or other computer belonging to the same group. It is additionally noted that, in the case where a node and/or other computer has allocated storage for storing backup data of other nodes and/or other computers, data received for backup from another node and/or other computer might, perhaps, be placed in the allocated storage.

According to various embodiments of the present invention, data to be backed up might be spread among multiple nodes and/or other computers, such that, for example, in operations of the sort discussed above, dispatched data to be backed up might represent only a portion of the total data to be backed up for a particular node and/or other computer.

For instance, the total amount of data to be backed up with respect to a particular node and/or other computer might be divided into a number of parts, with each portion being dispatched to a different node and/or computer for backup purposes. The parts might, perhaps, be of equal size to one another. In various embodiments, a user of a node and/or other computer might be able to specify (e.g., via a provided GUI and/or other interface) directives regarding such functionality.

Such directives might, for instance, include specification of the number of parts into which all or specified data to be backed up should be divided, specification of portion sizes (e.g., specified in numbers of bytes and/or as percentages of total size), and/or specification of correlations between portions and groups, and/or between portions and nodes and/or other computers (e.g., specification that a particular node and/or other computer should receive a particular portion, a particular size portion, and/or the like).

To illustrate by way of example, a node and/or other computer might belong to a backup group for which there were four other member nodes and/or other computers, and the total data to be backed up for the node and/or other computer might be broken up into four pieces. The first of the four pieces might be dispatched for backup to a first of the four other member nodes and/or other computers, the second of the four pieces might be dispatched for backup to a second of the four other member nodes and/or other computers, the third of the four pieces might be dispatched for backup to a third of the four other member nodes and/or other computers, and the fourth of the four pieces might be dispatched for backup to a fourth of the four other member nodes and/or other computers.

It is noted that recordation (e.g., a log) may be maintained regarding placement of data and/or portions thereof backed up with respect to a particular node and/or other computer. Accordingly, for instance, such recordation might indicate the particular nodes and/or other computers that have received a particular data portion for backup purposes.

In the case where data to be backed up has been previously dispatched to a particular node and/or other computer, for subsequent backup operations only those portions of the dispatched data that have changed might, in various embodiments, be dispatched to that particular node and/or other computer.

It is noted that, in the case where priorities are associated with data to be backed up, such priorities might, perhaps, be taken into account in backup. Multiple priority levels with corresponding backup behavior might, for instance, be established (e.g., by a user, a system administrator, and/or a manufacturer).

For example, a first priority level might be established such that data associated with the priority level would be backed up, via proximity connection, to any node and/or other computer available for receiving the backed up data (e.g., any node and/or other computer, reachable via proximity connection, that was a member of an appropriate backup group).

Such a first exemplary priority level might, perhaps, further provide that, in the case where backup is done via non-proximity connection (e.g., in the case where a certain amount of time has elapsed since the data was last backed up as discussed above), the data should be backed up to only one node and/or other computer.

As another example, a second priority level might be established such that data associated with the priority level would be backed up, via proximity connection, to only one node and/or other computer (e.g., a node and/or other computer that was a member of an appropriate backup group). As yet another example, a third priority level might be established such that data associated with the priority level would not be backed up as discussed herein.

In various embodiments, priority levels might be set by default to be associated with particular data, types of data and/or the like, with such settings perhaps being changeable (e.g., by a user). For instance, the above exemplary third priority level might be set by default to be associated with all data except for contacts data, with the exemplary first priority level being set by default to be associated with such data.

Functionality might, perhaps, be provided such that when data is dispatched among nodes and/or other computers, dispatch might be in an order that takes into account assigned priorities. For example, data associated with the above exemplary first priority level might be dispatched before data associated with the second above exemplary priority.

Moreover, functionality might, perhaps, be provided such that titles are be associated with priorities. For instance, the first exemplary priority level might be titled “critical”, the second exemplary priority level might be titled “normal”, and the third exemplary priority level might be titled “no backup”. Such titles might, perhaps, be presented to a user via a GUI and/or other interface (e.g., while she is selecting priorities to associate with data to be backed up).

It is noted that, in various embodiments, backup functionality may be provided by way of one or more software modules.

It is further noted that, in various embodiments, backup might be performed simultaneously for more than one node and/or other computer (e.g., for two nodes and/or other computers).

For instance, in the case where there were two nodes and/or other computers (e.g., belonging to a backup group), a connection for backup might be established between the first node and/or other computer and a node and/or other computer to receive backup data, and a connection might be established between the second node and/or other computer and the node and/or other computer to receive backup data. It is noted that, in various embodiments, one of such nodes and/or other computers might act to adopt the role of “master”.

Restore

According to various embodiments of the present invention, one or more operations may be performed in restoring data previously backed up to one or more nodes and/or other computers. Data restoration might be performed, for instance, in the case where data of a node and/or other computer is deleted (e.g., inadvertently) and/or corrupted, or where a node and/or other computer is replaced (e.g., for purposes of upgrade, because of failure, and/or because of loss or theft).

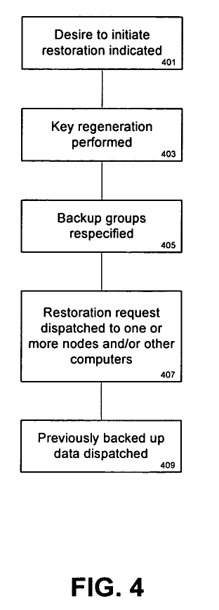

With respect to FIG. 4 it is noted that data restoration might be initiated in a number of ways. For example, a user, customer service representative, and/or system administrator might be able (e.g., via a GUI and/or other interface and/or by pressing a button)to indicate a desire to initiate restoration (step 401). As another example, restoration might be initiated automatically.

In various embodiments, in the case where a node and/or other computer is to receive previously backed up data, one or more setup operations that had been previously performed might be reperformed. For example, one or more keys that had been employed in backing up the data might be regenerated (step 403). One or more seeds, that had previously been employed in the creation of the one or more keys might, perhaps, be employed in key regeneration. Accordingly, for instance, a user might be queried (e.g., via a GUI and/or other interface) for the seeds.

As another example of setup operation reperformance, the user might be queried (e.g., via a GUI and/or other interface) to respecify one or more previously selected backup groups (step 405). As yet another example the user might be queried (e.g., via a GUI and/or other interface) to respecify allocation of storage for storing backup data of other nodes and/or other computers.

Perhaps after having reperformed one or more setup operations, one or more steps could be performed to receive previously backed up data. For example, the node and/or other computer seeking to receive previously backed up data might act to dispatch restoration request to one or more nodes and/or other computers (step 407). The nodes and/or other computers to which restoration request is dispatched might, for example, include one or more nodes and/or other computers of one or more backup groups to which the node and/or other computer that had previously had the data backed up belonged.

As another example, the nodes and/or other computers to which restoration request is dispatched might include one or mode nodes and/or other computers specified by recordation regarding placement of previously backed up data and/or portions thereof. It is noted that, in various embodiments, dispatched restoration request (e.g., a restoration request dispatched to a particular node and/or other computer) might, perhaps, specify particular sought data.

Nodes and/or other computers receiving restoration request may, for example, act to dispatch accessible (e.g., held in allocated storage) previously backed up data to the node and/or other computer seeking to receive previously backed up data (step 409). Where restoration request specifies particular sought data, dispatch of previously backed up data might, perhaps, satisfy the specification.

It is noted that, in various embodiments, in the case where a restoration request specified no particular sought data, a node and/or other computer receiving the restoration request might act to dispatch all data that it had received for backup from the node and/or other computer whose backed up data was being sought to the node and/or other computer seeking to receive previously backed up data.

Accordingly, via operations discussed herein, the node and/or other computer seeking to receive previously backed up data might, perhaps, come to receive previously backed up data from one or more nodes and/or other computers that receive restoration request. It is noted that dispatch of restoration request and/or dispatch of previously backed up data might involve use of proximity and/or non-proximity connection (e.g., of the sort discussed above).

For example, a user might be able to specify (e.g., via a GUI and/or other interface) which of proximity and non-proximity connection she wished to be employed for various purposes. As another example, functionality might be such that proximity connection is employed preferentially over non-proximity connection. For instance, functionality might be such that proximity connection is attempted but, if not achieved with in a particular time period (e.g., one specified by a user, a system administrator, and/or a manufacturer), non-proximity connection is employed.

In various embodiments, after receiving previously backed up data, the node and/or other computer seeking to receive previously backed up data might act to perform one or more operations. For example, in the case where received previously backed up data is in encrypted form, the node and/or other computer may act to decrypt the data (e.g., via use of one or more, perhaps regenerated, keys). As another example, in the case where received previously backed up data is divided into pieces, the node and/or other computer may act to reassemble the data.

It is noted that, in various embodiments, in restoration one or more pairing operations might, perhaps in a manner analogous to that discussed above, be performed. It is further noted that, in various embodiments, a user of a node and/or other computer receiving a restoration request might be queried (e.g., via a GUI and/or other interface) as to whether or not backed up data should be provided to a requesting node and/or other computer, with backed up data only being dispatched where the user provided permission to do so.

It is additionally noted that, in various embodiments, a node and/or other computer receiving a restoration request might act to consider the node and/or other computer that dispatched the request to replace the node and/or other computer whose backed up data was being sought. Accordingly, for instance, accessible data corresponding to the node and/or other computer whose backed up data was being sought might be updated to correspond to the node and/or other computer that dispatched the request.

Moreover, it is noted that, in various embodiments, restore functionality may be provided by way of one or more software modules.

Hardware and Software

Various operations and/or the like described herein may be executed by and/or with the help of computers. Further, for example, devices described herein may be and/or may incorporate computers. The phrases “computer”, “general purpose computer”, and the like, as used herein, refer but are not limited to a smart card, a media device, a personal computer, an engineering workstation, a PC, a Macintosh, a PDA, a portable computer, a computerized watch, a wired or wireless terminal, phone, node, and/or the like, a server, a network access point, a network multicast point, a set-top box, a personal video recorder (PVR), a game console, or the like, perhaps running an operating system such as OS X, Linux, Darwin, Windows CE, Windows XP, Windows Server 2003, Palm OS, Symbian OS, or the like, perhaps employing the Series 40 Platform, Series 60 Platform, and/or Series 90 Platform, and perhaps having support for Java and/or .Net.

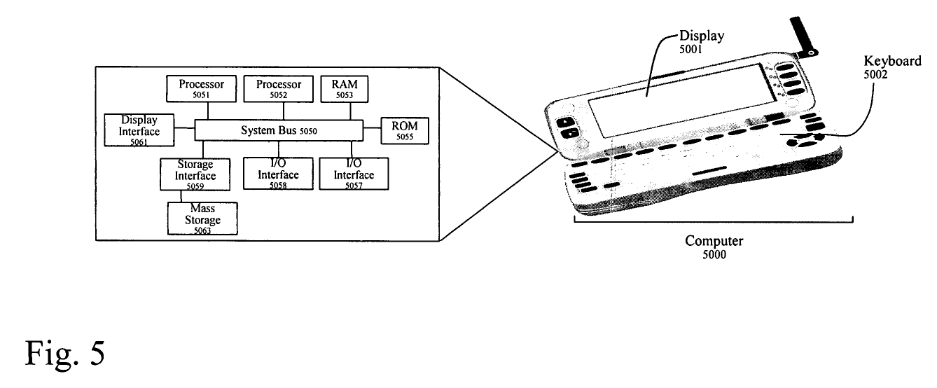

The phrases “general purpose computer”, “computer”, and the like also refer, but are not limited to, one or more processors operatively connected to one or more memory or storage units, wherein the memory or storage may contain data, algorithms, and/or program code, and the processor or processors may execute the program code and/or manipulate the program code, data, and/or algorithms. Accordingly, exemplary computer 5000 as shown in FIG. 5 includes system bus 5050 which operatively connects two processors 5051 and 5052, random access memory 5053, read-only memory 5055, input output (I/O) interfaces 5057 and 5058, storage interface 5059, and display interface 5061. Storage interface 5059 in turn connects to mass storage 5063. Each of I/O interfaces 5057 and 5058 may, for example, be an Ethernet, IEEE 1394, IEEE 1394b, IEEE 802.11a, IEEE 802.11b, IEEE 802.11g, IEEE 802.11i, IEEE 802.11e, IEEE 802.11n, IEEE 802.15a, IEEE 802.16a, IEEE 802.16d, IEEE 802.16e, IEEE 802.16x, IEEE 802.20, IEEE 802.15.3, ZigBee, Bluetooth, Wireless Universal Serial Bus (WUSB), wireless Firewire, terrestrial digital video broadcast (DVB-T), satellite digital video broadcast (DVB-S), Advanced Television Systems Committee (ATSC), Integrated Services Digital Broadcasting (ISDB), Digital Audio Broadcast (DAB), General Packet Radio Service (GPRS), Universal Mobile Telecommunications Service (UMTS), Global System for Mobile Communications (GSM), DVB-H (Digital Video Broadcasting: Handhelds), IrDA (Infrared Data Association), and/or other interface.

Mass storage 5063 may be a hard drive, optical drive, or the like. Processors 5051 and 5052 may each be a commonly known processor such as an IBM or Motorola PowerPC, an AMD Athlon, an AMD Opteron, an Intel ARM, an Intel XScale, a Transmeta Crusoe, a Transmeta Efficeon, an Intel Xenon, an Intel Itanium, or an Intel Pentium. Computer 5000 as shown in this example also includes a touch screen 5001 and a keyboard 5002. In various embodiments, a mouse, keypad, and/or interface might alternately or additionally be employed. Computer 5000 may additionally include or be attached to card readers, DVD drives, floppy disk drives, hard drives, memory cards, ROM, and/or the like whereby media containing program code (e.g., for performing various operations and/or the like described herein) may be inserted for the purpose of loading the code onto the computer.

In accordance with various embodiments of the present invention, a computer may run one or more software modules designed to perform one or more of the above-described operations. Such modules might, for example, be programmed using languages such as Java, Objective C, C, C#, C++, Perl, and/or Xen according to methods known in the art. Corresponding program code might be placed on media such as, for example, DVD, CD-ROM, and/or floppy disk. It is noted that any described division of operations among particular software modules is for purposes of illustration, and that alternate divisions of operation may be employed. Accordingly, any operations discussed as being performed by one software module might instead be performed by a plurality of software modules. Similarly, any operations discussed as being performed by a plurality of modules might instead be performed by a single module. It is noted that operations disclosed as being performed by a particular computer might instead be performed by a plurality of computers. It is further noted that, in various embodiments, peer-to-peer and/or grid computing techniques may be employed.

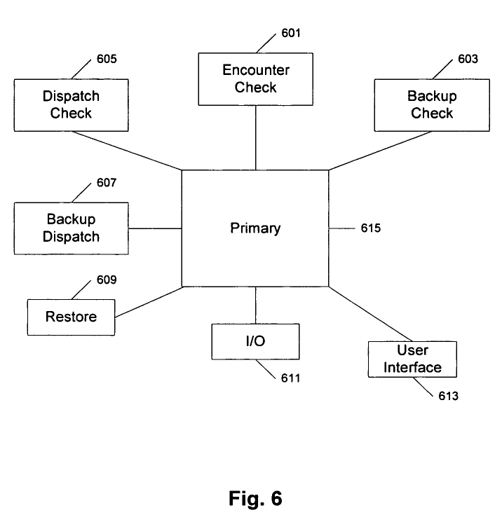

Shown in FIG. 6 are exemplary software modules employable in various embodiments of the present invention. Shown in FIG. 6 are encounter check module 601, backup check module 603, dispatch check module 605, backup dispatch module 607, restore module 609, input-output module 611, user interface module 613, and primary module 615.

Encounter check module 601 might, in various embodiments, be employed, for instance, in checking whether a node and/or other computer in proximity connection range belonged to one or more existing backup groups. Operation of the software module might, for example, involve consulting, in view of an identifier of a node and/or other computer in proximity connection range, an accessible store having identifiers of nodes and/or other computers belonging to existing backup groups.

Backup check module 603 might, in various embodiments, be employed, for instance, in checking whether there is data to be backed up. Operation of the software module might, for example, involve consideration of priorities, consideration of currently backed up data, and/or consideration of changes to data specified for backup. Dispatch check module 605 might, in various embodiments, be employed, for instance, in checking if data (e.g., changed data) is to be dispatched to a node and/or other computer in proximity connection range. Operation of the software module might, for example, involve consideration of data already backed up to the node and/or other computer in proximity connection range, and/or consideration of changes to data specified for backup.

Backup dispatch module 607 might, in various embodiments, be employed, for instance, in dispatching data to be backed up to a node and/or other computer (e.g., one in proximity connection range). Restore module 609 might, in various embodiments, be employed, for instance, in requesting and/or receiving data previously backed up to one or more nodes and/or other computers.

Input-output module 611 might, in various embodiments, be employed, for instance, in various communications (e.g., dispatch and/or receipt) operations discussed herein. User interface module 613 might, in various embodiments, be employed, for instance, in implementation of various user interfaces (e.g., GUIs) discussed herein. Primary module 615 might, in various embodiments, be employed, for instance, in performing various operations discussed herein (e.g., operations discussed herein not performed by one or more of software modules 601-613).

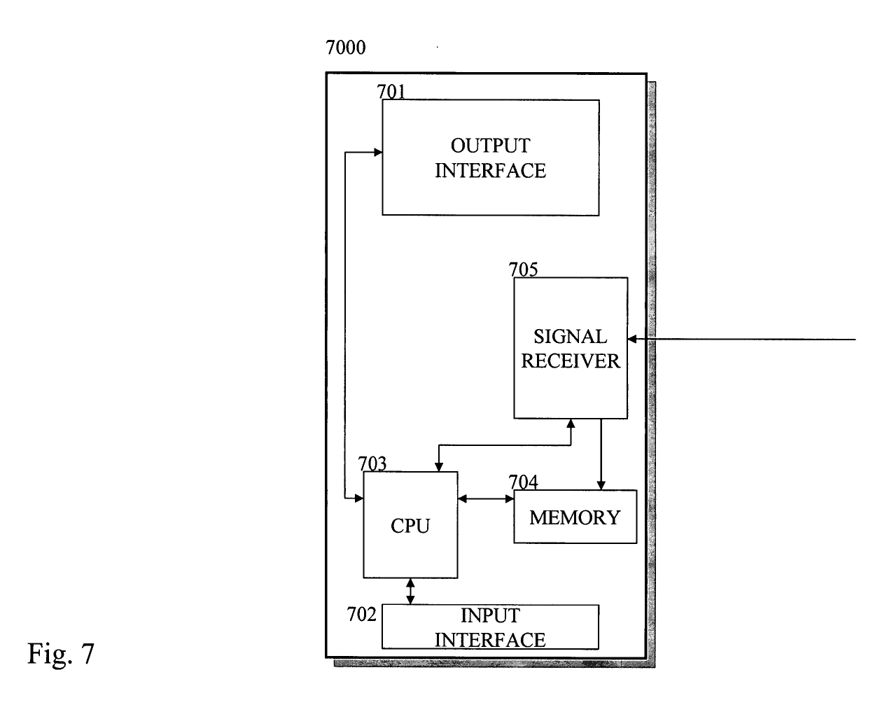

Shown in FIG. 7 is a block diagram of a terminal, an exemplary computer employable in various embodiments of the present invention. In the following, corresponding reference signs are applied to corresponding parts. Exemplary terminal 7000 of FIG. 7 comprises a processing unit CPU 703, a signal receiver 705, and a user interface (701, 702). Signal receiver 705 may, for example, be a single-carrier or multi-carrier receiver. Signal receiver 705 and the user interface (701, 702) are coupled with the processing unit CPU 703. One or more direct memory access (DMA) channels may exist between multi-carrier signal terminal part 705 and memory 704. The user interface (701, 702) comprises a display and a keyboard to enable a user to use the terminal 7000. In addition, the user interface (701, 702) comprises a microphone and a speaker for receiving and producing audio signals. The user interface (701, 702) may also comprise voice recognition (not shown).

The processing unit CPU 703 comprises a microprocessor (not shown), memory 704 and possibly software. The software can be stored in the memory 704. The microprocessor controls, on the basis of the software, the operation of the terminal 7000, such as receiving of a data stream, tolerance of the impulse burst noise in data reception, displaying output in the user interface and the reading of inputs received from the user interface. The hardware contains circuitry for detecting signal, circuitry for demodulation, circuitry for detecting impulse, circuitry for blanking those samples of the symbol where significant amount of impulse noise is present, circuitry for calculating estimates, and circuitry for performing the corrections of the corrupted data.

Still referring to FIG. 7, alternatively, middleware or software implementation can be applied. The terminal 7000 can, for instance, be a hand-held device which a user can comfortably carry. The terminal 7000 can, for example, be a cellular mobile phone which comprises the multi-carrier signal terminal part 705 for receiving multicast transmission streams. Therefore, the terminal 7000 may possibly interact with the service providers.

Ramifications and Scope

Although the description above contains many specifics, these are merely provided to illustrate the invention and should not be construed as limitations of the invention's scope. Thus it will be apparent to those skilled in the art that various modifications and variations can be made in the system and processes of the present invention without departing from the spirit or scope of the invention.

In addition, the embodiments, features, methods, systems, and details of the invention that are described above in the application may be combined separately or in any combination to create or describe new embodiments of the invention.

What is claimed is:

1. A method, comprising:
detecting a node of a user to be in proximity connection range with a node of a backup group; and
backing up data held by the node of the user to the node of the backup group, wherein a proximity connection between the node of the user and the node of the backup group is employed.

2. The method of claim 1, further comprising determining that there is data to be backed up.

3. The method of claim 1, further comprising determining the node of the backup group to belong to the backup group.

4. The method of claim 1, wherein the node of the user belongs to the backup group.

5. The method of claim 1, wherein the user specifies data to be backed up.

6. The method of claim 1, wherein the user specifies one or more priorities for data to be backed up.

7. The method of claim 1, wherein data not backed up to the node of the backup group is backed up, via proximity connection, to a second node of the backup group.

8. The method of claim 1, wherein the node of the backup group has storage allocated for storing backup data of other nodes of the backup group.

9. The method of claim 1, wherein the node of the user has storage allocated for storing backup data of other nodes of the backup group.

10. The method of claim 1, wherein data received by the node of the backup group is encrypted.

11. The method of claim 10, wherein an encrypted key generated from a seed is employed.

12. The method of claim 11, wherein the seed is selected by the user.

13. The method of claim 1, wherein the node of the user receives via proximity connection for backup data held by a node of the backup group.

14. The method of claim 1, wherein data held by the node of the user is backed up via a non-proximity connection in the case where a specified time threshold is met.

15. The method of claim 1, wherein data held by the node of the user is backed up via a non-proximity connection in response to user specification.

16. The method of claim 1, wherein the node of the user has access to indication of one or more locations of backed up data.

17. The method of claim 1, wherein only changed data is backed up.

18. The method of claim 1, wherein the proximity connection employs Bluetooth.

19. The method of claim 1, wherein the proximity connection employs IEEE 802.11.

20. The method of claim 1, wherein the proximity connection employs ultra wide band.

21. The method of claim 1, wherein at least some backed up data is restored to a node of the user.

22. The method of claim 21, wherein key regeneration is performed.

23. The method of claim 22, wherein the user provides a previously provided seed.

24. The method of claim 21, wherein a proximity connection is employed in restoration.

25. The method of claim 21, wherein a non-proximity connection is employed in restoration.

26. A method, comprising:
receiving via proximity connection at a first node from a second node data held by the second node, wherein the first node and the second node belong to a backup group; and
storing the received data in storage of the first node allocated for storing backup data of other nodes.

27. The method of claim 26, wherein a user of the second node specifies data to be backed up.

28. The method of claim 26, wherein a user of the second node specifies one or more priorities for data to be backed up.

29. The method of claim 26, wherein data not backed up to the first node is backed up, via proximity connection, to another node of the backup group.

30. The method of claim 26, wherein the second node has storage allocated for storing backup data of other nodes of the backup group.

31. The method of claim 26, wherein the received data is encrypted.

32. The method of claim 31, wherein an encrypted key generated from a seed is employed.

33. The method of claim 32, wherein the seed is selected by a user of the second node.

34. The method of claim 26, wherein the second node receives via proximity connection for backup data held by the first node.

35. The method of claim 26, wherein data held by the second node is backed up via a non-proximity connection in the case where a specified time threshold is met.

36. The method of claim 26, wherein data held by the second node is backed up via a non-proximity connection in response to user specification.

37. The method of claim 26, wherein the second node has access to indication of one or more locations of backed up data.

38. The method of claim 26, wherein only changed data is backed up.

39. The method of claim 26, wherein the proximity connection employs Bluetooth.

40. The method of claim 26, wherein the proximity connection employs IEEE 802.11.

41. The method of claim 26, wherein the proximity connection employs ultra wide band.

42. The method of claim 26, wherein at least some backed up data is restored.

43. The method of claim 42, wherein key regeneration is performed.

44. The method of claim 43, wherein a user provides a previously provided seed.

45. The method of claim 42, wherein a proximity connection is employed in restoration.

46. The method of claim 42, wherein a non-proximity connection is employed in restoration.

47. A method, comprising:
dispatching a restoration request to one or more nodes of one or more backup groups; and
receiving, via proximity connection, previously backed up data from one or more of the one or more nodes.

48. The method of claim 47, further comprising regenerating one or more keys employed in data backup.

49. The method of claim 47, wherein one or more previously selected backup groups are specified.

50. A system, comprising:
a memory having program code stored therein; and
a processor disposed in communication with the memory for carrying out instructions in accordance with the stored program code;
wherein the program code, when executed by the processor, causes the processor to perform:
detecting a node of a user to be in proximity connection range with a node of a backup group; and
backing up data held by the node of the user to the node of the backup group, wherein a proximity connection between the node of the user and the node of the backup group is employed.

51. The system of claim 50, wherein the processor further performs determining that there is data to be backed up.

52. The system of claim 50, wherein the processor further performs determining the node of the backup group to belong to the backup group.

53. The system of claim 50, wherein the node of the user belongs to the backup group.

54. The system of claim 50, wherein the user specifies data to be backed up.

55. The system of claim 50, wherein the user specifies one or more priorities for data to be backed up.

56. The system of claim 50, wherein data not backed up to the node of the backup group is backed up, via proximity connection, to a second node of the backup group.

57. The system of claim 50, wherein the node of the backup group has storage allocated for storing backup data of other nodes of the backup group.

58. The system of claim 50, wherein the node of the user has storage allocated for storing backup data of other nodes of the backup group.

59. The system of claim 50, wherein data received by the node of the backup group is encrypted.

60. The system of claim 59, wherein an encrypted key generated from a seed is employed.

61. The system of claim 60, wherein the seed is selected by the user.

62. The system of claim 50, wherein the node of the user receives via proximity connection for backup data held by a node of the backup group.

63. The system of claim 50, wherein data held by the node of the user is backed up via a non-proximity connection in the case where a specified time threshold is met.

64. The system of claim 50, wherein data held by the node of the user is backed up via a non-proximity connection in response to user specification.

65. The system of claim 50, wherein the node of the user has access to indication of one or more locations of backed up data.

66. The system of claim 50, wherein only changed data is backed up.

67. The system of claim 50, wherein the proximity connection employs Bluetooth.

68. The system of claim 50, wherein the proximity connection employs IEEE 802.11.

69. The system of claim 50, wherein the proximity connection employs ultra wide band.

70. The system of claim 50, wherein at least some backed up data is restored to a node of the user.

71. The system of claim 70, wherein key regeneration is performed.

72. The system of claim 71, wherein the user provides a previously provided seed.

73. The system of claim 70, wherein a proximity connection is employed in restoration.

74. The system of claim 70, wherein a non-proximity connection is employed in restoration.

75. A system, comprising:
a memory having program code stored therein; and
a processor disposed in communication with the memory for carrying out instructions in accordance with the stored program code;
wherein the program code, when executed by the processor, causes the processor to perform:
receiving via proximity connection at a first node from a second node data held by the second node, wherein the first node and the second node belong to a backup group; and
storing the received data in storage of the first node allocated for storing backup data of other nodes.

76. The system of claim 75, wherein a user of the second node specifies data to be backed up.

77. The system of claim 75, wherein a user of the second node specifies one or more priorities for data to be backed up.

78. The system of claim 75, wherein data not backed up to the first node is backed up, via proximity connection, to another node of the backup group.

79. The system of claim 75, wherein the second node has storage allocated for storing backup data of other nodes of the backup group.

80. The system of claim 75, wherein the received data is encrypted.

81. The system of claim 80, wherein an encrypted key generated from a seed is employed.

82. The system of claim 81, wherein the seed is selected by a user of the second node.

83. The system of claim 75, wherein the second node receives via proximity connection for backup data held by the first node.

84. The system of claim 75, wherein data held by the second node is backed up via a non-proximity connection in the case where a specified time threshold is met.

85. The system of claim 75, wherein data held by the second node is backed up via a non-proximity connection in response to user specification.

86. The system of claim 75, wherein the second node has access to indication of one or more locations of backed up data.

87. The system of claim 75, wherein only changed data is backed up.

88. The system of claim 75, wherein the proximity connection employs Bluetooth.

89. The system of claim 75, wherein the proximity connection employs IEEE 802.11.

90. The system of claim 75, wherein the proximity connection employs ultra wide band.

91. The system of claim 75, wherein at least some backed up data is restored.

92. The system of claim 91, wherein key regeneration is performed.

93. The system of claim 92, wherein a user provides a previously provided seed.

94. The system of claim 91, wherein a proximity connection is employed in restoration.

95. The system of claim 91, wherein a non-proximity connection is employed in restoration.

96. A system, comprising:
a memory having program code stored therein; and
a processor disposed in communication with the memory for carrying out instructions in accordance with the stored program code;
wherein the program code, when executed by the processor, causes the processor to perform:
dispatching a restoration request to one or more nodes of one or more backup groups; and
receiving, via proximity connection, previously backed up data from one or more of the one or more nodes.

97. The system of claim 96, wherein the processor further performs regenerating one or more keys employed in data backup.

98. The system of claim 96, wherein one or more previously selected backup groups are specified.

99. An article of manufacture comprising a computer readable medium containing program code that when executed causes a wireless node to perform:
detecting the wireless node to be in proximity connection range with a node of a backup group; and
backing up data held by the wireless node to the node of the backup group, wherein a proximity connection between the wireless node and the node of the backup group is employed.

100. An article of manufacture comprising a computer readable medium containing program code that when executed causes a wireless node to perform:
receiving via proximity connection at the wireless node from a second node data held by the second node, wherein the wireless node and the second node belong to a backup group; and
storing the received data in storage of the wireless node allocated for storing backup data of other nodes.

101. An article of manufacture comprising a computer readable medium containing program code that when executed causes a wireless node to perform:
dispatching a restoration request to one or more nodes of one or more backup groups; and
receiving, via proximity connection, previously backed up data from one or more of the one or more nodes of one or more backup groups.
